(19) United States
(12) Patent Application Publication
(10) Pub. No.: US 2014/0156851 A1
(43) Pub. Date: Jun. 5, 2014

(54) SERVER FACILITY, METHOD FOR PROVIDING COPYING SERVICE FOR SYSTEM OF SERVER FACILITY, AND COPYING PROGRAM FOR SYSTEM OF SEVER FACILITY

(71) Applicant: FUJITSU LIMITED, Kawasaki-shi (JP)

(72) Inventors: Ichiro Suami, Yokohama (JP); Michito Ichimaru, Fukuoka (JP); Sojiro Kinoshita, Kitakyushu (JP)

(73) Assignee: FUJITSU LIMITED, Kawasaki-shi (JP)

(21) Appl. No.: 14/093,278

(22) Filed: Nov. 29, 2013

(30) Foreign Application Priority Data
Nov. 30, 2012 (JP) 2012-263780

(51) Int. Cl. H04L 12/911

(52) U.S. Cl. CPC H04L 47/70
USPC 709/226

(57) ABSTRACT

A server facility includes a hardware resource group including at least a plurality of servers and a plurality of storage units; and a management server configured to store a user template file that contains information on a virtual system including a plurality of virtual machines, in a storage area, and facilitate the virtual system by assigning hardware in the hardware resource group to the user template file. The hardware resource group includes a plurality of hardware blocks each including a predetermined number of servers and storage units. In response to a virtual system copying request to copy a copying target virtual system of a first user to a second hardware block of a second user, the management server determines whether the second hardware block is able to provide a virtual machine in the copying target virtual system of the first user.

### CROSS-REFERENCE TO RELATED APPLICATION

This application is based upon and claims the benefit of priority of the prior Japanese Patent Application No. 2012-263780, filed on Nov. 30, 2012, the entire contents of which are incorporated herein by reference.

### FIELD

The present invention relates to a server facility, a method for providing a copying service for a system of a server facility, and a copying program for a system of a server facility.

### BACKGROUND

In recent years, a cloud computing service by a server facility is being widely provided. As one cloud computing service, an infrastructure itself for virtual machines and networks, is provided as a service via the Internet, so as to be a foundation for a computer to be constructed and operated.

In this service, a user selects a virtual machine having a desired processing capability from a user interface screen, selects an operation system (hereafter OS) of the virtual machine, and constructs a virtual system. The virtual system is constructed by assigning the necessary hardware resources in a hardware resource group to the selected virtual machine and OS. In the initial state of the virtual system, the user installs middleware and application programs to the virtual machine in the virtual system, performs various settings via the user interface screen, sets a network of the virtual system, and stores data in the virtual machine in the virtual system.
[Patent Document 1] Japanese Patent Application Laid-Open No. 2011-70627
[Non-patent Document 1] FUJITSU 61, 3 (05, 2010)

### SUMMARY

The user operates the virtual system while receiving the infrastructure of the hardware of the virtual system constructed as mentioned above as a service via the Internet. In this case, there is demand to copy the constructed virtual system directly for another user. A virtual system based on a virtual machine is constructed by assigning hardware resources to a template (template file or image file) that includes information on the virtual machine, OS, installed middleware, application programs, network settings and user data or the like. Therefore a copied template is created by first copying the template, and new hardware resources are assigned to the copied template so that a virtual system, the same as the original virtual system, is generated.

A hardware resource group, on the other hand, is managed by being segmented into hardware blocks, which include a predetermined number of servers and storage units, as the minimum constituent units, so as to make management of hardware resources easier. Hardware and OS are upgraded as time progresses, so corresponding to an upgrade, hardware blocks necessary for the server facility are introduced at every predetermined number of years or period, and are provided as hardware resources of the virtual system of the user. Needless to say, new hardware blocks can provide a virtual machine with enhanced performance compared to the case of old hardware blocks. A management server of the server facility assigns each user with hardware blocks that the user can use, and assigns the virtual machine or the like in the hardware blocks of the user to the virtual system of the user.

However because of restrictions in managing hardware resources, the user can use only the virtual server in the assigned hardware block, and is restricted to using a virtual server in another hardware block that is outside the assigned hardware block.

In some cases, when the virtual system is copied, a virtual system, to which a virtual machine is assigned, in a hardware block may be copied to another hardware block. If the hardware block at the copy source has a high performance virtual machine and the hardware block at the copy destination has only a low performance virtual machine, and the virtual system at the copy source includes the high performance virtual machine, the same virtual machine cannot be constructed in the hardware block at the copy destination.

According to an aspect of the embodiment, a server facility, includes:

a hardware resource group including at least a plurality of servers and a plurality of storage units; and

a management server configured to store a user template file that contain information on a virtual system including a plurality of virtual machines, in a storage area, and facilitate the virtual system by assigning hardware in the hardware resource group to the user template file, wherein

the hardware resource group includes a plurality of hardware blocks each of which includes a first number of servers and a second number of storage units, and

in response to a virtual system copying request to copy a copying target virtual system of a first user, to which hardware in a first hardware block of the first user is assigned, to a second hardware block of a second user, the management server determines whether the second hardware block is able to provide a virtual machine in the copying target virtual system of the first user.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting a configuration example of a server facility.

FIG. 2 is a diagram depicting an example of a hardware resource group in the server facility.

FIG. 3 is a diagram depicting a procedure for the user to construct the virtual system, and a procedure to copy the virtual system.

FIG. 4 is a flow chart depicting a procedure for the user to construct the virtual system.

FIG. 5 is a diagram depicting an example of a template file.

FIG. 6 is a diagram depicting hardware blocks in the hardware resource group 10.

FIG. 7 is a diagram depicting a configuration of hardware blocks in a server facility.

FIG. 8 is an example of a performance level and the OS of virtual machines VM, each of which can be provided by a plurality of hardware blocks.

FIG. 9 is a diagram depicting a copying processing of a virtual system between different hardware blocks.

FIG. 10 is a flow chart depicting processing by the management server for the copy source user terminal U1.

FIG. 11 is an example of a management table of users and hardware blocks assigned to the users.

FIG. 12 is an example of a management table of the performance level, copy key, copy destination ID or the like of each template.

FIG. 13 is a diagram depicting the determination processing by the management server.

FIG. 14 is a diagram depicting another determination processing by the management server.

FIG. 15 is a flow chart depicting a virtual system copy processing by the management server for the copy destination user terminal.

FIG. 16 is a diagram depicting a copy of the template and correction of the copied template.

FIG. 17 is a diagram depicting correction of the template in concrete terms.

FIG. 18 is a flow chart depicting the template copying processing S38 and S42 in FIG. 15.

FIG. 19 illustrates examples of user interfaces of the copy source user terminal.

FIG. 20 are examples of user interfaces of the copy destination user terminal.

FIG. 21 is a diagram depicting screens during copying the template in step S42.

### DESCRIPTION OF EMBODIMENTS

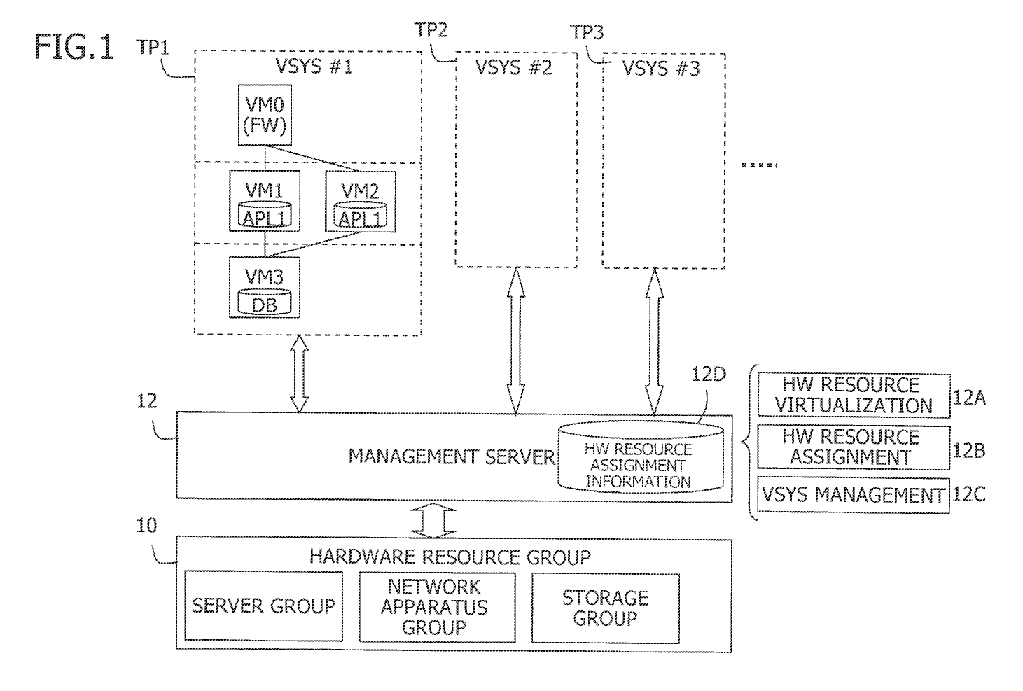

FIG. 1 is a diagram depicting a configuration example of a server facility. The server facility includes: a hardware resource group 10 including a plurality of servers, a plurality of storage units and a plurality of network apparatuses; and a management server 12 which facilitates a virtual system VSYS by assigning hardware in the hardware resource group 10 to template files TP1, TP2 and TP3 holding information on the virtual system having a virtual machine that is created by a user.

The major functions of the management server 12 are: a function 12A that virtualizes the hardware resources in the hardware resource group 10; a function 12B that constructs a virtual machine by assigning hardware resources in the hardware resource group to the virtual machines in the template files TP1, TP2 and TP3; and a virtual system management function 12C that provides a graphic user interface (GUI) to the user and provides services to construct the virtual system, perform operation or facilitation management and copy of a virtual system via the GUI. When hardware resources are assigned to a template file, the management server 12 stores the hardware resource assignment information 12D in a storage area in the management server.

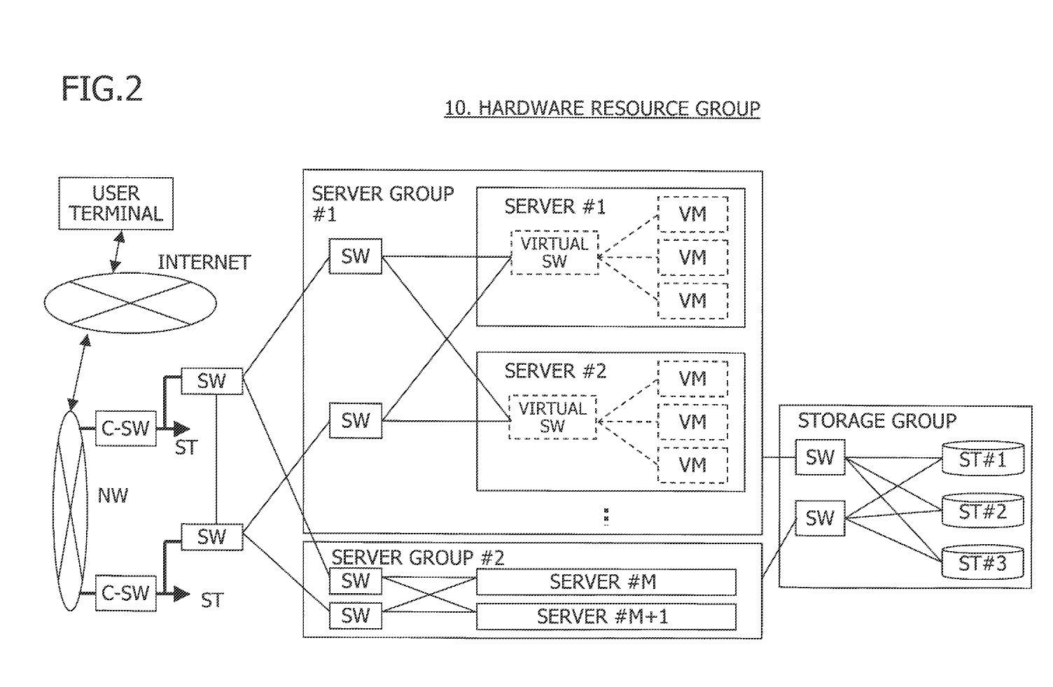

FIG. 2 is a diagram depicting an example of a hardware resource group in the server facility. The hardware resource group 10 includes: a server group; a network apparatus group; and a storage group. FIG. 2 illustrates server groups #1 and #2. The server groups #1 and #2 are separated by a server rack, for example, but are logically the same server groups. In server group #1, a plurality of servers are installed, those servers are uniformly connected via switches SW, and are connected to the network NW via a core switch C-SW, so as to be accessed from the Internet. The network apparatus group includes apparatuses constructed by switches SW and servers.

The storage group includes a plurality of storage units ST#1, ST#2 and ST#3 which are connected to the network via switches SW.

As illustrated in FIG. 2, each server is configured into a plurality of virtual machines VM by the virtualization function of the management server 12 in FIG. 1, and these virtual machines VM are connected to the network via virtual switches SW.

[Template File and Systematization]

Now template files and systematization thereof will be described. The server facility provides an infrastructure of a virtual system constructed by a user as a service via the Internet. For this service, the management server of the server facility provides a GUI to the user so that the user can construct a virtual system.

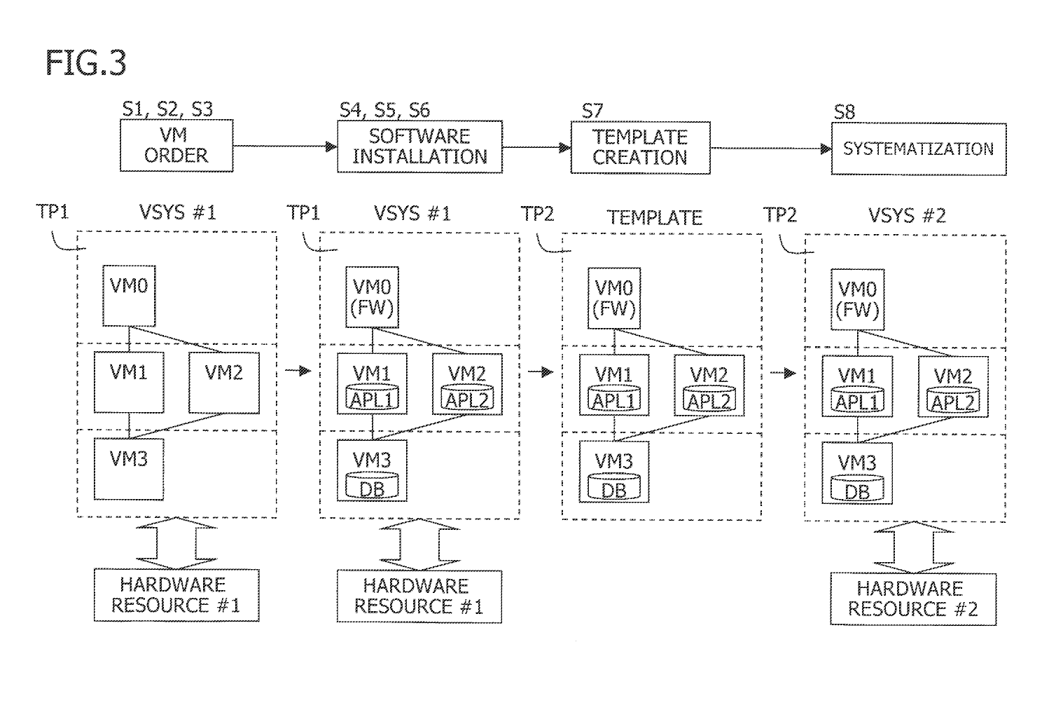

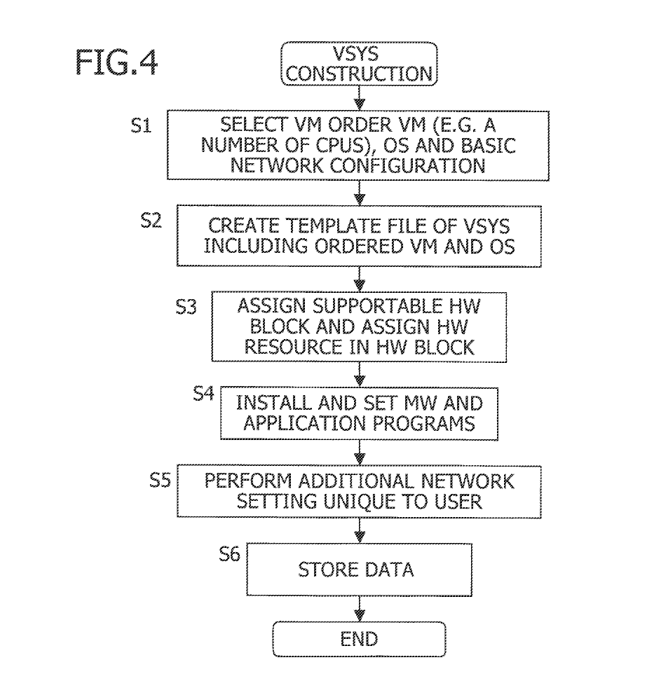

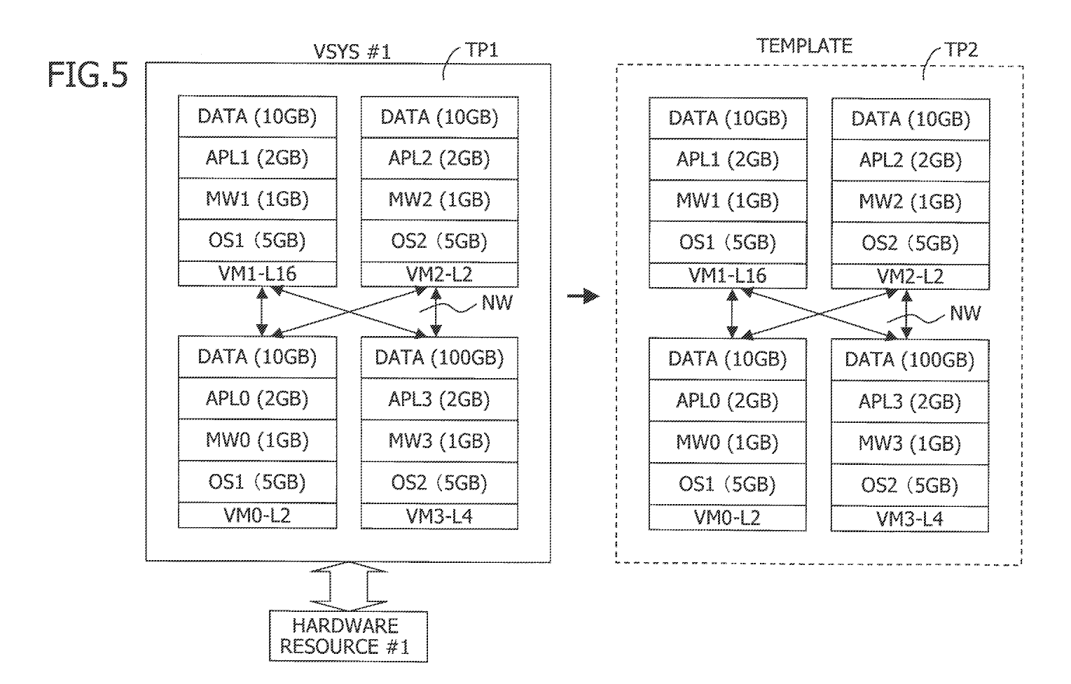

FIG. 3 is a diagram depicting a procedure for the user to construct the virtual system, and a procedure to copy the virtual system. FIG. 4 is a flow chart depicting a procedure for the user to construct the virtual system. FIG. 5 is a diagram depicting an example of a template file. The procedure for the user to construct the virtual system and the procedure to copy the virtual system will be described with reference to these drawings.

The template file is a data file that includes not only information on a virtual machine, but also on OS, middleware, application programs and data itself, and may simply be referred to as “template” in some cases hereinbelow, of which meaning is still the same.

According to the procedure to construct the virtual system, when the user selects and orders a virtual machine VM and OS to be installed and a basic network configuration via the GUI of the management server (S1), a template TP1 of a virtual system VSYS#1 having the ordered virtual machine VM is generated in a hard disk area (storage area) of a server in the hardware resource group 10 (S2). The template TP1 at the left in FIG. 3 includes four virtual machines VM0 to VM3 connected via a network, and OSs (not illustrated) installed thereon.

The user selects a desired virtual machine VM via the GUI out of the plurality of virtual machines having various performance levels that can be provided as a service. Further, the user selects a desired OS out of the plurality of OSs that can be installed on the virtual machine VM. The performance level of a virtual machine VM is classified depending on a number of CPUs, memory capacity, hard disk capacity or the like. This means that a virtual machine VM having a desired performance with a desired number of CPUs, memory capacity and hard disk capacity can be selected by selecting a virtual machine VM having a desired performance level. A number of CPUs of a virtual machine VM that can be provided is, for example, 1, 2, 4, 8, 16 or 32, so as to implement various performance levels. Various performance levels can also be provided depending on the memory capacity and hard disk capacity as well.

The user can also select a virtual storage via the GUI, and store the virtual storage in the template TP1.

A selected OS is installed on the plurality of virtual machines VM ordered by the user. In concrete terms, when the user selects an OS to be installed on a virtual machine VM via the GUI, a program file of the OS is stored in the template file TP1, and is installed on the virtual machine VM. This installation of the OS on the virtual machine VM is equivalent to installation of an OS on a hard disk of a standard PC. In other words, the template file here corresponds to a file group, such as a system file, software file and data on a hard disk of a standard PC. In the case of a server facility, however, an actual server is virtualized into a virtual machine, so an OS is not installed on a hard disk of an actual operating server.

As mentioned later, the hardware resource group of the server facility includes a plurality of hardware blocks. A hardware block is the minimum constituent unit of the hardware resource group, including a predetermined number of servers and a predetermined number of storage units which are installed at a same period. The management server 12 selects a hardware block that can provide a virtual machine VM having a selected performance level, and stores the template TP1 in a management area of the management server in the hardware block.

The management server 12 assigns such hardware resource as a server and storage unit in the hardware block to a virtual machine or a virtual storage in the template TP1 of the virtual system created by the user (S3). When hardware resources are assigned to the template TP1, a virtual system VSYS#1 is constructed by the template TP1 and the assigned hardware resource, and can be facilitated. This is systematization processing.

FIG. 5 is a diagram depicting an example of a template file. The template TP1 illustrated in FIG. 5 includes the files of four virtual machines VM0, VM1, VM2 and VM3, and the files of the OSs to be installed on the four virtual machines. The template TP1 in FIG. 5 also includes the middleware MW, the application programs APL to be installed, and the data DATA. The four virtual machines VM0, VM1, VM2 and VM3 include the selected performance levels L2, L16, L2 and L4 respectively as attributes thereof. Hardware resources are assigned to the template TP1 in FIG. 5 to construct the virtual machine VSYS#1.

Referring back to FIG. 3 and FIG. 4, the user installs the necessary middleware MW and application programs AP on each virtual machine VM via the GUI, and performs the necessary settings (S4). Thereby as the template TP1 in FIG. 5 indicates, the files of actual middleware MW, the files of application programs APLs, and the setting information thereof, corresponding to each virtual machine VM, are added to the template file TP1. Furthermore, the user adds the network settings unique to the user to the virtual system via the GUI (S5). Thereby the network setting information NW is added to the template TP1 in FIG. 5. Then the user stores data in the virtual machine VM as necessary via the GUI (S6). Thereby actual data DATA is added to the template TP1 in FIG. 5.

The virtual machine VM1, for example, in the template TP1 in FIG. 5 has a relatively high performance level, L16, and for this virtual machine VM1, the template TP1 includes a 5 GB file of the operation system OS1, a 1 GB file of middleware MW1, a 2 GB file of application programs AP1, 10 GB of data DATA, and network setting information NW. The virtual system is constructed and operated by assigning hardware resources to the virtual machine in the template TP1.

The three segments indicated by the broken lines in template TP1 depicted in FIG. 3 correspond, for example, to the settings of the network configuration. For example, the virtual machine VM0 is constructed in a firewall server FW with the Internet, the virtual machines VM1 and VM2 are constructed in a server that implements a desired application APL1, APL2, and the virtual machine VM3 is constructed in a data base server DB respectively. In this way, the virtual machine VM3 is expected to function as a data base server, and has a 100 GB data capacity, which is larger than the other virtual machines VM0, VM1 and VM2.

In the process until the virtual system is operated, the data DATA is increased/decreased, new application programs are added, or various setting information is updated, but all this information is included in the template TP1.

Therefore the template file corresponds to a system file, OS file, program file and data, which are stored in a hard disk in a standard PC. In the server facility, however, the hardware resources are virtualized, so a server that is different from the server in which the template is stored or that is the same as the server in which the template file is stored is assigned as the hardware resource.

[Copy Processing of Virtual System]

A copy processing of the virtual system will be described with reference to FIG. 3 and FIG. 5. As mentioned above, the virtual system is able to be constructed by assigning hardware resources, such as an arbitrary server, to a template on a hard disk of an arbitrary server according to virtualization of the hardware resources. Utilizing the characteristics of the virtualization of the hardware resources, the constructed virtual system is able to simply be copied.

First in FIG. 3 and FIG. 5, the operation of the virtual system VSYS#1, which has already been systematized, is stopped. Then the template TP1 of the virtual system VSYS#1 is copied to another template TP2, which is stored on the hard disk (S7). This copied template TP2 includes the same information as the template TP1 of the currently operating virtual system VSYS#1. The data DATA in the template TP1, however, may or may not be included in the copied template TP2 depending on necessity.

FIG. 5 depicts specific files and setting information of the copied template TP2. In the example of FIG. 5, the copied template TP2 is the same as the copy source template TP1, and includes the data DATA of the template TP1 as well. This copied template TP2, however, is not yet systematized since hardware resources are not assigned.

As illustrated in FIG. 3, if hardware resources are assigned to virtual machines of the copied template TP2 by the management server 12 in FIG. 1, a copied virtual system VSYS#2 is constructed. The copied virtual system VSYS#2 is a system having a same configuration as the copy source virtual system VSYS#1, but hardware resources assigned to the virtual system VSYS#2 is different from those assigned to the virtual system VSYS#1.

[Hardware Blocks of Hardware Resource Group]

Hardware blocks in the hardware resource group will be described next.

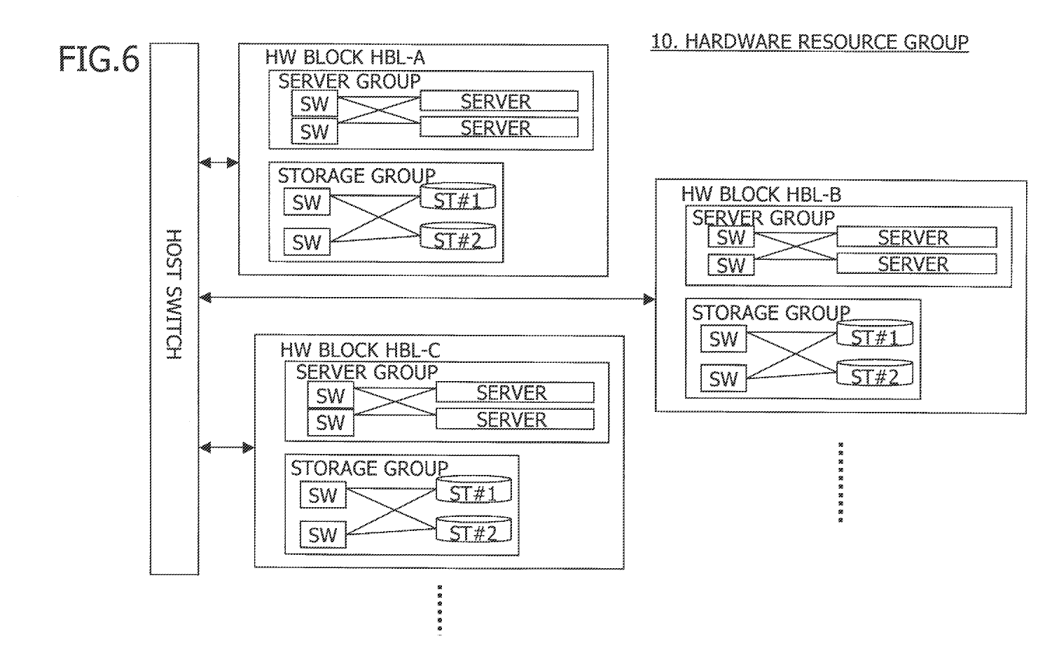

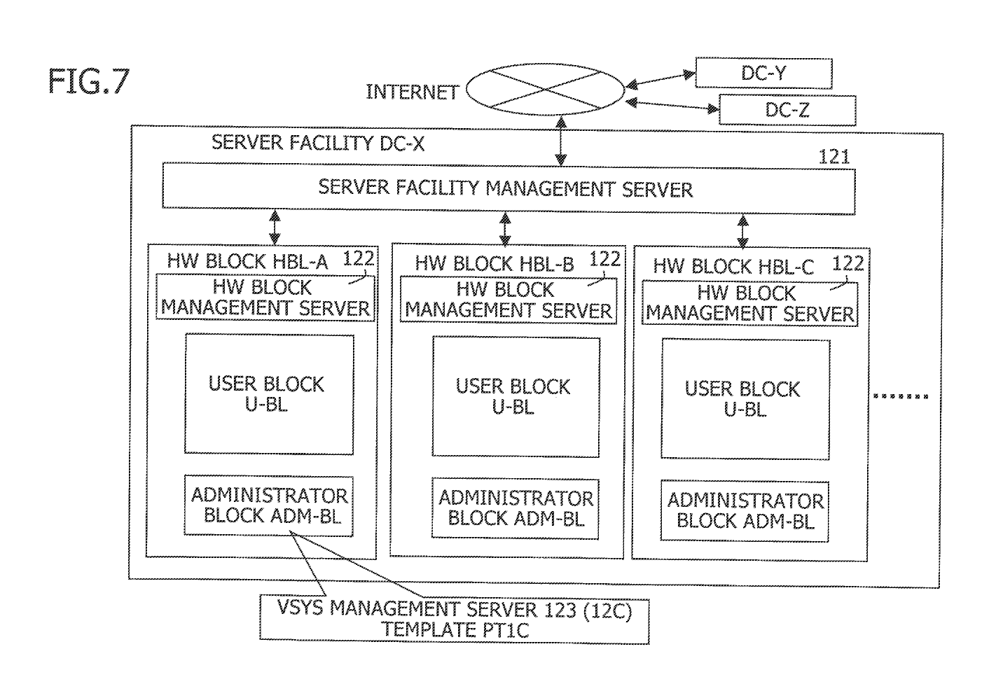

FIG. 6 is a diagram depicting hardware blocks in the hardware resource group 10. FIG. 7 is a diagram depicting a configuration of hardware blocks in a server facility.

As mentioned above, in order to make management of the hardware resources easier, the hardware resource group 10 is managed by segmenting hardware blocks HBL, including a predetermined number of servers and a predetermined number of storage units as the minimum constituent units. In the example in FIG. 6, three hardware blocks HBL-A, HBL-B and HBL-C are connected via host switches. The configuration of the hardware resources in each hardware block HBL is the same as the hardware resources depicting in FIG. 2, and are constituted by a server group, a storage group and switches SW of a network apparatus, for example.

The hardware and OS are upgraded as time progresses, so corresponding to an upgrade, new hardware blocks are installed in the server facility at every predetermined number of years or period, and are provided as hardware resources of the virtual system of the user. For example, a performance level of a virtual machine in old hardware blocks installed in the past is different from that of the functional blocks of a virtual machine in new hardware blocks installed recently, and in some cases, the new hardware blocks is able to provide a higher performance virtual machine. Furthermore, an OS that the old hardware block is able to provide and an OS that the new hardware block is able to provide may be different.

Therefore in order to make management of the hardware resources easier, the management server of the server facility manages each unit of the hardware blocks which were installed in the same time period. Because of this restriction in managing the hardware resources, the management server assigns the hardware blocks to users as follows.

When the virtual machine VM illustrated in FIG. 3 is ordered, a hardware block, which is able to provide the virtual machine VM having a performance level that the user desires and which is available to assign the hardware to the user, is selected, and the hardware block is assigned to the user.

The management server stores the template file TP1 of the user in a storage area in the hardware blocks assigned to the user, and assigns the hardware resource in the hardware block, which is assigned to the user, to the template TP1.

The information on the hardware block assigned to the user is not disclosed due to the restrictions in managing hardware resources. Further, the user is able to use only the virtual machine and the virtual storage in the hardware block assigned to the user, and is restricted to using a virtual machine and a virtual storage in another hardware block outside the hardware block that is assigned to the user.

As one restriction of the public cloud for many general users who share hardware resources in a server facility, the service level agreement (SLA) with the user determines that the virtual machine and the OS desired by the user are provided, but infrastructure attribute information, such as which hardware block of which server facility the hardware resource to be assigned is located in, is not disclosed to the user. This is because the public cloud generally prohibits users to recognize or speculate on the hardware resource access state of another user. Therefore basically information on the assigned hardware block is not disclosed to the user.

FIG. 7 illustrates the hardware blocks (HW blocks) HBL-A, HBL-B and HBL-C in a server facility DC-X. A server facility management server 121 in the server facility is able to communicate with other server facilities via the Internet, and is able to also communicate with a user terminal (not illustrated) via the Internet.

Each of the plurality of hardware blocks HBL-A, HBL-B and HBL-C includes a hardware block management server 122, a user block U-BL and an administrator block ADM-BL respectively. The server facility management server 121 and each hardware block management server 122 have the hardware resource assignment function 12B and the hardware resource virtualization function 12A described in FIG. 1.

The management server having the VSYS management function 12C described in FIG. 1 is constructed by the hardware resource in the administrator block ADM-BL. A template file TP of the user assigned to the hardware block HBL is stored in the hard disk area of the hardware resource in the administrator block ADM-BL. The hardware block management server 122 assigns the hardware resource in the user block U-BL to the template TP of the user, and operates or facilitates and manages the hardware resource along with the server facility management server 121.

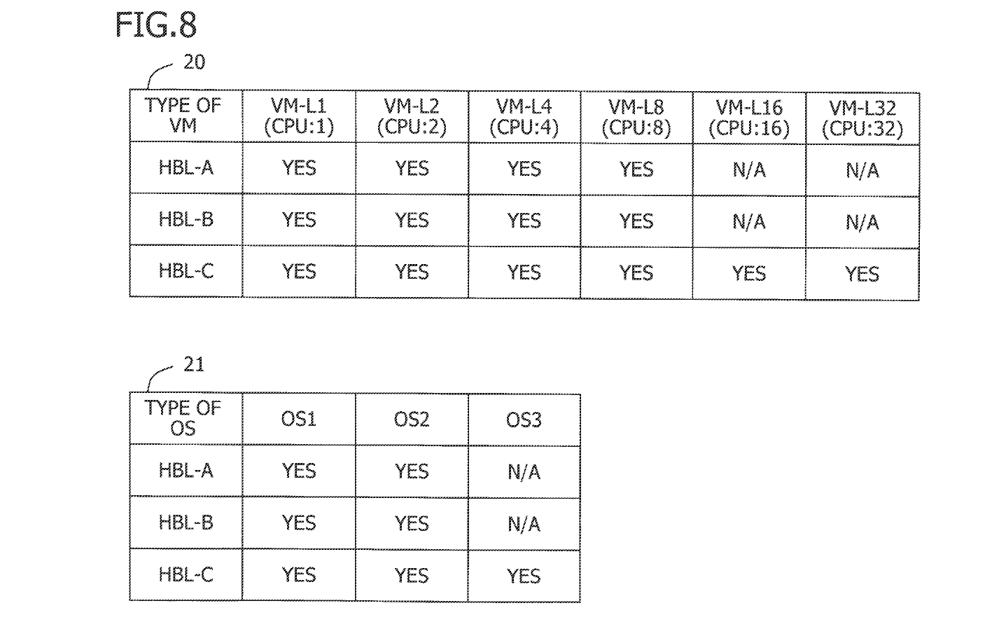

FIG. 8 is an example of a performance level and the OS of virtual machines VM, each of which is able to be provided by a plurality of hardware blocks. A management table 20 indicates the virtual machine types that three hardware blocks: HBL-A, HBL-B and HBL-C is able to provide to the user. The six virtual machine types VM-L1 to VM-L32 are constituted by 1, 2, 4, 8, 16 and 32 CPUs respectively, for example, and the performance level thereof sequentially increases. The performance level of a virtual machine VM is determined not only by the number of CPUs, but also by the memory capacity, hard disk capacity or the like. Therefore the performance levels of the virtual machines in the management table 20 are examples.

In this example, the two hardware blocks HBL-A and HBL-B were constructed a relatively long time ago. Therefore the hardware blocks HBL-A and HBL-B are able to provide virtual machines VM-L1 to VM-L32 having six types of performance levels to users, except for virtual machine VM-L16 constituted by 16 CPUs and virtual machine VM-L32 constituted by 32 CPUs. The hardware block HBL-C, on the other hand, was constructed relatively recently, for example. Therefore the hardware block HBL-C is able to provide all virtual machines VM-L1 to VM-L32 having six types of performance levels to users.

The management table 21 indicates the types of OS which the three hardware blocks HBL-A, HBL-B and HBL-C are able to provide to users. In this example, OS1 and OS2, out of the three OSs (OS1, OS2 and OS3) are relatively old OSs, and OS3 is a relatively new OS. Therefore the two hardware blocks HBL-A and HBL-B are able to provide OS1 and OS2 (excluding OS3), out of the three OSs, to users. Whereas the relatively new hardware block HBL-C is able to provide all three OSs (OS1, OS2 and OS3) to users.

These hardware block management tables 20 and 21 are stored, for example, in a storage area of a VSYS management server 123 of the administrator block ADM-BL in each hardware block HBL or in the storage area of the hardware block management server 122 or the server facility management server 121.

[Outline of this Embodiment]

As mentioned above, a virtual system the same as an original virtual system is constructed when a template of the virtual system is copied and a hardware resource is assigned to the copied template.

However if a virtual system constructed in a first hardware block of a first user is constructed in a second hardware block by copying the virtual system, the following problem occurs. That is, if the first hardware block at the copy source is able to provide a high performance virtual machine to the user, and the second hardware block at the copy destination is able to provide only a low performance virtual machine to the user, and if the virtual system at the copy source includes a high performance virtual machine, then the same virtual system cannot be constructed in the second hardware block at the copy destination.

Therefore according to this embodiment, in response to a virtual system copying request between different hardware blocks received from the user, the management server detects whether the above mentioned problem occurred, and outputs a warning or changes the copied template to solve the problem if necessary.

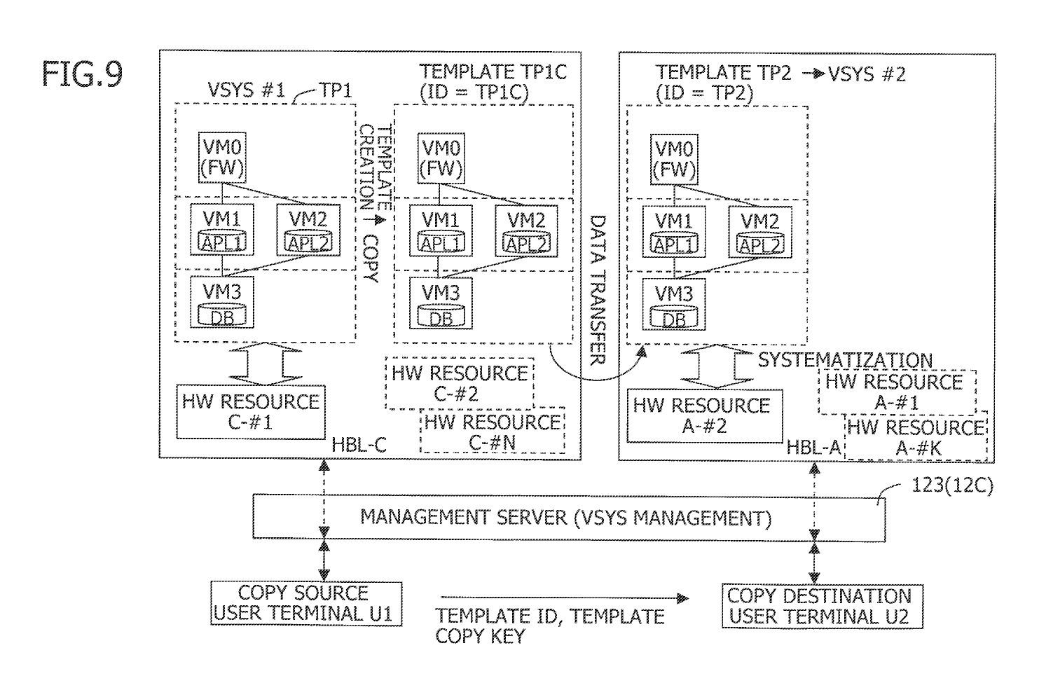

FIG. 9 is a diagram depicting a copying processing of a virtual system between different hardware blocks. In the example illustrated in FIG. 9, a virtual system VSYS#1, which is constructed in a hardware block HBL-C that is able to provide high performance virtual machines VM-BL16, VM-BL32 and a relatively new OS3, is copied to a hardware block HBL-A that cannot provide such high performance virtual machines and OS3.

First a terminal U1 of a copy source user logs in to the management server 123 using a copy source user ID. By an instruction from the terminal U1 of the copy source user, the management server 123 stops the virtual system VSYS#1 which was constructed in the hardware block HBL-C and is currently in-operation, copies the template TP1 of the virtual system VSYS#1, and generates a new template TP1C. This new template TP1C is stored in a storage area in an operation server in the same hardware block HBL-C. At this time, the management server 123 issues ID=TP1C as the template ID to the new template TP1C.

If the template ID is selected from the copy source user terminal UI, the management server 123 issues a template copy key that corresponds to the template ID. If the copy destination user ID is specified by the copy source user terminal UI, the management server 123 determines whether the hardware resource in the hardware block HBL-A assigned to the copy destination user ID is able to provide the virtual machine VM, OS or the like of the template TP1C, and outputs a warning when necessary if the provision is not possible. If it is determined that the provision is possible, or if a consent to the warning is received from the copy source user terminal UI when the provision is impossible, the management server 123 registers the copy destination user ID for this template ID and template copy key. The template ID and template copy key correspond one-to-one, and a single or a plurality of copy destination user ID(s) is further corresponded thereto.

As a result, a copy source user transfers the template ID (=TP1C) of the virtual system to be copied and the template copy key to the copy destination user. Thereby the copy destination user becomes ready for operation to copy the virtual system.

Now the terminal U2 of the copy destination user logs in to the management server 123 using the copy destination user ID. When a template copying instruction is received from the terminal U2 of the copy destination user, along with the template ID and the copy key, the management server 123 checks whether the copy destination user ID is authorized to copy the template having the template ID.

If copying is authorized, the management server 123 determines whether the hardware resource of the hardware block HBL-A assigned to the copy destination user ID is able to provide the virtual machine VM or the like in the copy source template TP1C, and outputs a warning when necessary if the provision is not possible. If it is determined that the provision is possible or if a consent to the warning is received from the copy destination user terminal U2 when the provision is impossible, the management server 123 transfers the template TP1C in the hardware block HBL-C of the copy source user to the storage area in the hardware block HBL-A of the copy destination user, and stores the data in the storage area. Thereby the copied template TP2 is generated in the storage area of the hardware block HBL-A of the copy destination user, and ID=TP2 as a template ID is issued to the template TP2.

Finally responding to a systematization request from the copy destination user terminal U2, the management server 123 assigns the hardware resource in the hardware block HBL-A to the copied template TP2, and performs systematization. Thereby the copied virtual system VSYS#2 is able to be operated from the copy destination terminal U2.

As a concrete processing for copying a virtual system, processing by the copy source user terminal U1 and processing by the copy destination user terminal U2 will be described.

[Processing by Management Server for Copy Source User Terminal U1]

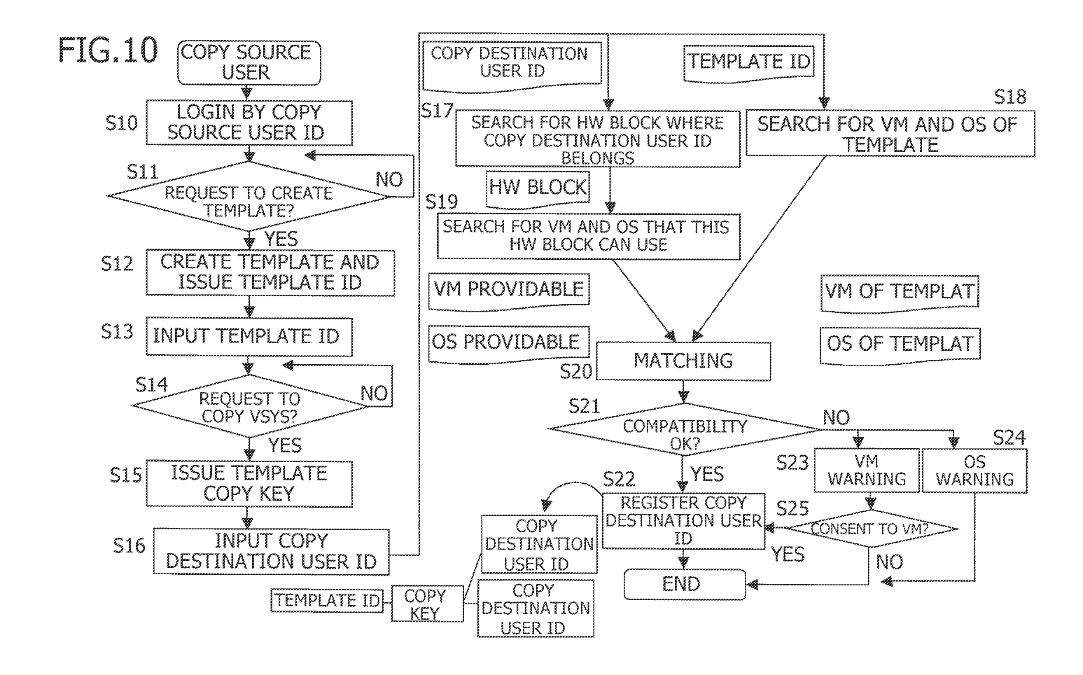

FIG. 10 is a flow chart depicting processing by the management server for the copy source user terminal U1. The management server 123 authenticates login from the copy source user terminal U1 using the copy source user ID, then accepts login (S10). After receiving a template creation request from the copy source user terminal U1 in a state of stopping operation of the virtual system VSYS#1 (S11), the management server 123 generates a copied template TP1C by copying the template TP1 of the virtual system VSYS#1, stores the copied template TP1C in the storage area in the hardware block HBL-C of the copy source user, and issues a template ID (ID=TP1C) (S12).

Then the copy source user terminal U1 inputs or selects a template ID (S13), and if the management server 123 receives a virtual system copying request for the template ID at this time (S14), the management server 123 issues a template copy key (S15).

When the copy source user terminal U1 inputs the ID of a copy destination user to copy the virtual system (S16), the management server 123 determines whether the hardware resource of the hardware block HBL-A assigned to the copy destination user ID is able to provide the virtual machine VM, OS or the like of the template TP1C.

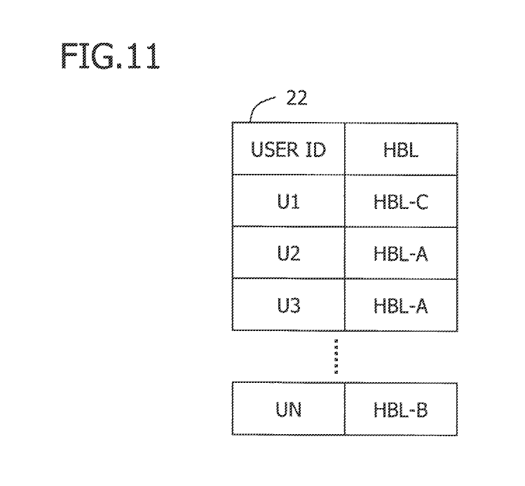

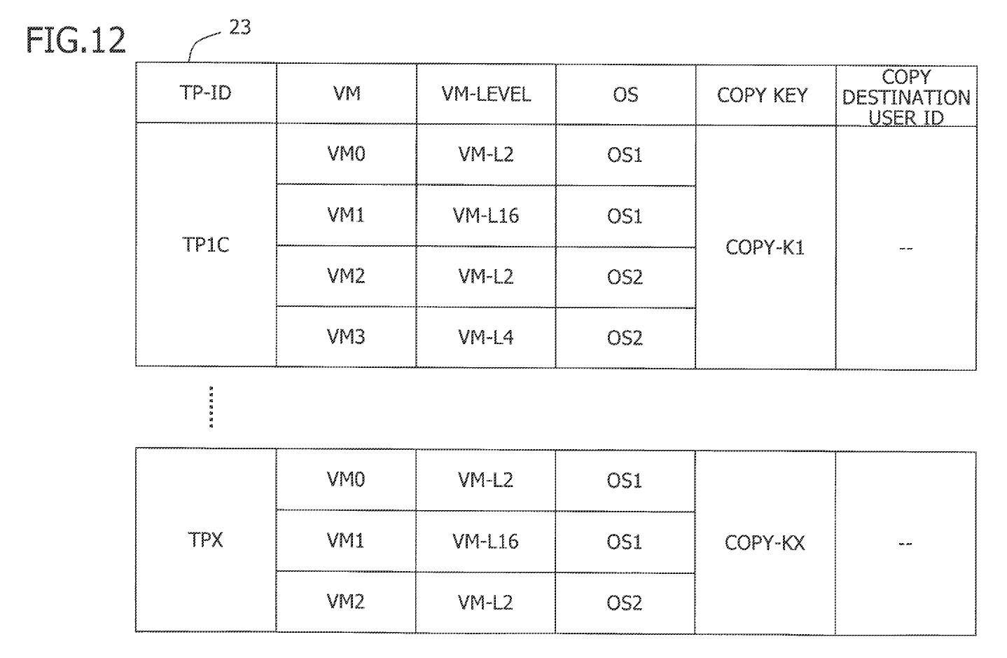

FIG. 11 is an example of a management table of users and hardware blocks assigned to the users. FIG. 12 is an example of a management table of the performance level, copy key, copy destination ID or the like of each template. This management table is held by the management server 123, for example.

In the example of the management table 22 in FIG. 11, the copy source user U1 is assigned to the hardware block HBL-C, and the hardware resource of this block is used to construct a virtual system. In the same manner, the copy destination user U2 is assigned to the hardware block HBL-A, and the hardware resource of this block is used to construct a virtual system. The same is true for other users.

In the example of the management table 23 in FIG. 12, the template TP1C of which template ID is TP1C has four virtual machines, VM0 to VM3, of which performance levels are VM-L2, VM-L16, VM-L2 and VM-L4 respectively, on which OS1, OS1, OS2 and OS2 are installed respectively as the OS. A template copy key COPY-K1 has been issued to the template TP1C where the copy destination ID has not yet been registered.

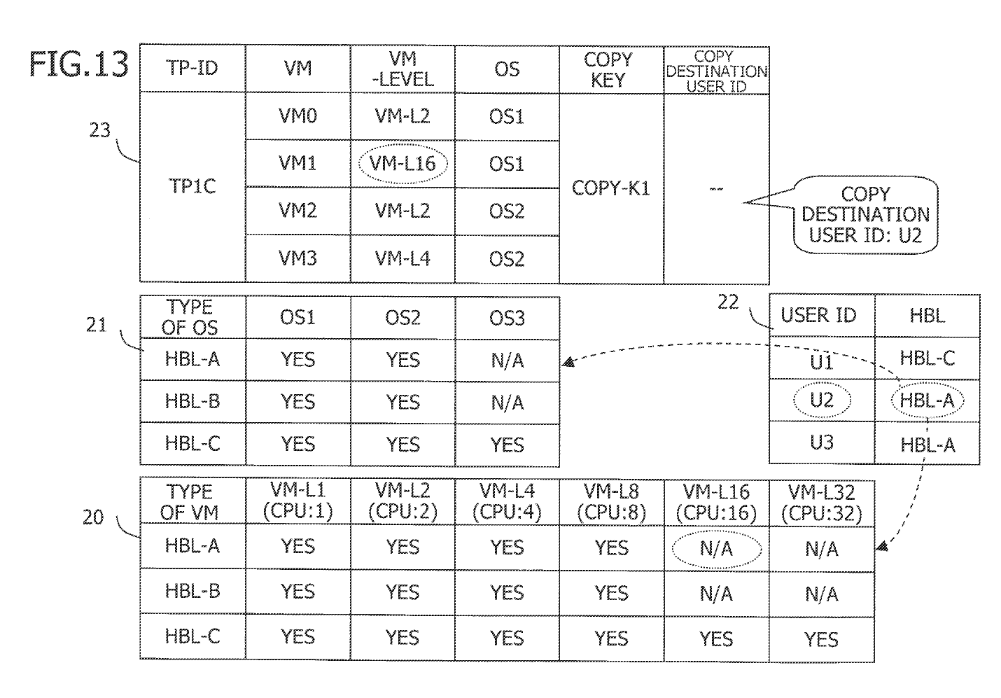

Referring back to FIG. 10, the determination processing by the management server 123 will be described. FIG. 13 is a diagram depicting the determination processing by the management server. First as illustrated in FIG. 13, the management server 123 refers to the management table 22 in FIG. 11, and searches for the hardware block with the copy destination user ID (S17). As a result, it is detected that the hardware block of the copy destination user ID=U2 is HBL-A. Then the management server 123 refers to the management tables 20 and 21 in FIG. 8, and searches for a virtual machine VM, OS or the like which the hardware block HBL-A is able to provide, that is, which is able to be used in the hardware block HBL-A (S19).

The management server 123, on the other hand, refers to the management table 23 in FIG. 12, as illustrated in FIG. 13, and searches for a performance level and OS of the virtual machine of the template TP1C to be copied (S18).

As illustrated in FIG. 13, the management server 123 matches a virtual machine VM that the hardware block of the copy destination user is able to provide and a virtual machine VM of the template TP1C to be copied, and checks whether all the virtual machines VM of the template TP1C to be copied are included in the virtual machines VM that the hardware block of the copy destination user is able to provide (S20). In the example in FIG. 13, the hardware block HBL-A cannot provide the performance level VM-L16 of the virtual machine VM in the template TP1C. Therefore the management server 123 determines “Incompatible” (NO in S21), and outputs such a warning as “This template includes a server type (virtual machine type) that does not exist in the copy destination.” to the copy source user terminal U1 (S23). The warning message may also be “This template includes a server type (virtual machine type) that does not exist in the copy destination. A server type (virtual machine type) with a lower performance level will be assigned at the copy destination. Is this OK?” In the case of this warning message, a type of virtual machine of the template copied, when copying the system to the copy destination user, is automatically changed to a closest type of virtual machine in the hardware block of the copy destination user. Details will be described later.

If consent to a warning is received from the copy source user terminal U1 (YES in S25), or if compatibility is detected in the matching processing (YES in S21), then the management server 123 registers U2 as the copy destination user ID in the template TP1C, as illustrated in FIG. 13 (S22). As illustrated in FIG. 10, a plurality of copy destination user IDs may be registered corresponding to template ID and copy key.

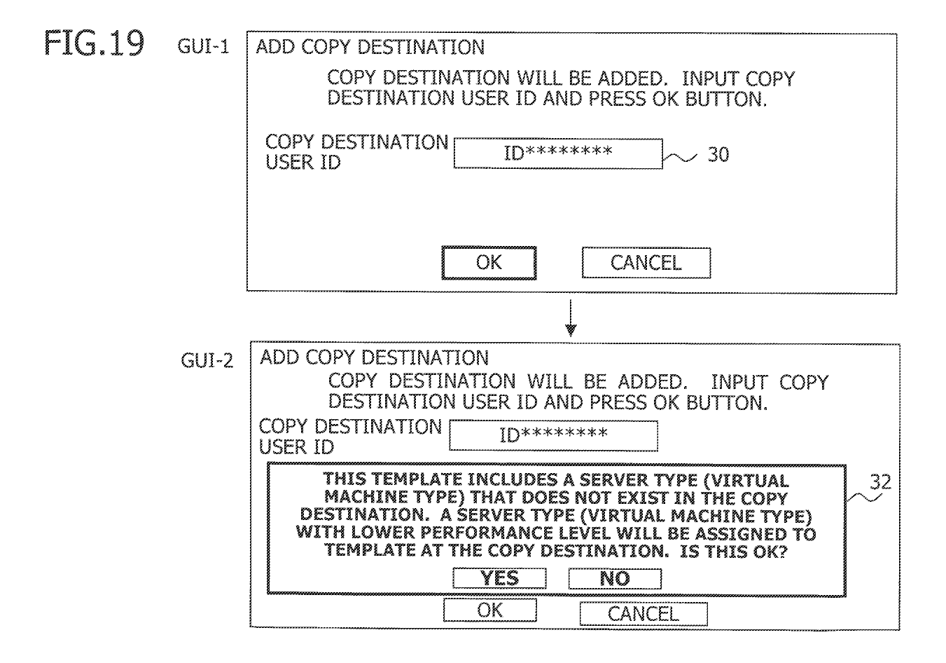

FIG. 19 illustrates examples of user interfaces of the copy source user terminal. The interface screen GUI-1 in FIG. 19 is an input screen for inputting a copy destination user ID in step S16 in FIG. 10. If the copy source user inputs a copy destination user ID in a copy destination user ID input box 30 in the screen GUI-1, and presses the OK button, the management server executes steps S17 to S21 in FIG. 10 in the background, and if incompatibility is detected for any reason, a box 32, including the above mentioned warning message, is outputted as indicated in the screen GUI-2. If the copy source user selects “YES” in the warning message box, the management server registers the copy destination user ID.

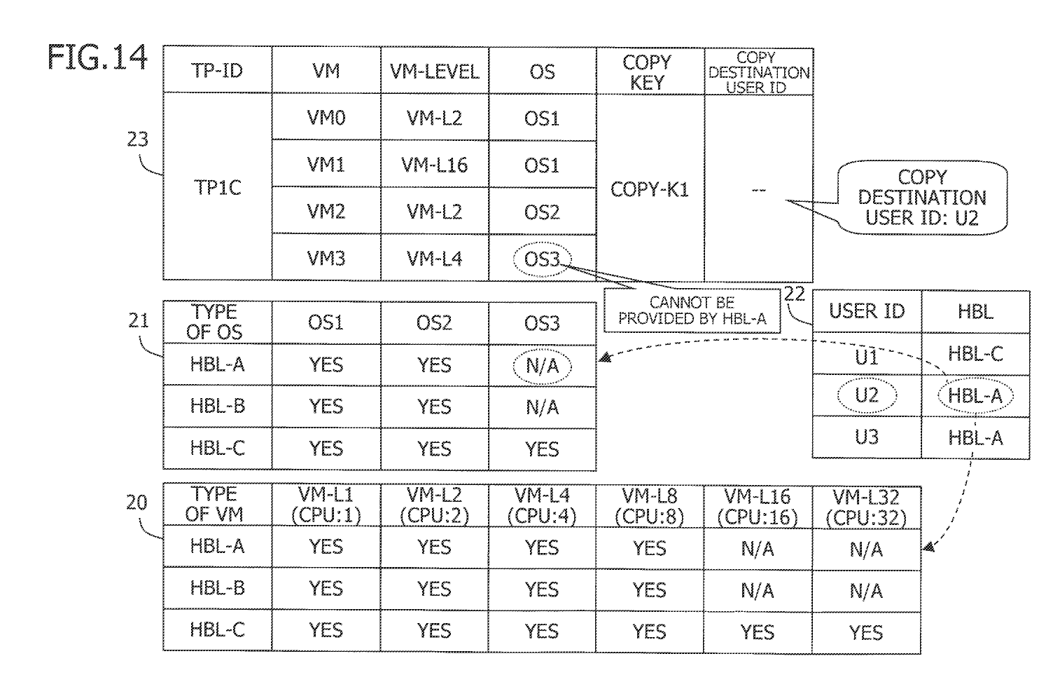

FIG. 14 is a diagram depicting another determination processing by the management server. In this example, unlike FIG. 13, the template TP1C to be copied includes OS3. In this case, the management server 123 refers to the management table 21, detects that OS3 in the template TP1C is not able to be provided by the hardware block HBL-A of the copy destination user, determines this state as “Incompatible” (NO in S21), outputs such a warning as “This template includes an OS that does not exist in the copy destination.” to the copy source user terminal U1 (S24), and rejects registration of the copy destination user ID. If the OS is not compatible, registration of the copy destination user ID is rejected since it is difficult to change the OS that is able to be provided in the hardware block HBL-A of the copy destination user due to restriction in facilitating or managing the hardware block.

In the above embodiment, the number of CPUs was used as an example of the performance level of the virtual machine, but the performance level may also vary depending on memory capacity or disk capacity. It may be determined whether the hardware block of the copy destination user is able to provide these performance levels as well.

In this way in response to the virtual system copying request from the copy source user terminal U1, the management server determines whether the hardware block of the copy destination user is able to provide the performance level of the virtual machine and such software as an OS, including in the template of the virtual system, and if the management server is able to handle the request for the copy destination user, the management server outputs a warning to the copy source user terminal, and registers the copy destination user ID when the copy source user terminal consents, and if the management server is not able to handle the request for the copy destination unser, the management server rejects the registration. As a result, the management server is able to appropriately handle a virtual system copying request between different hardware blocks, without causing inconvenience to users.

[Processing by Management Server for Copy Destination User Terminal U2]

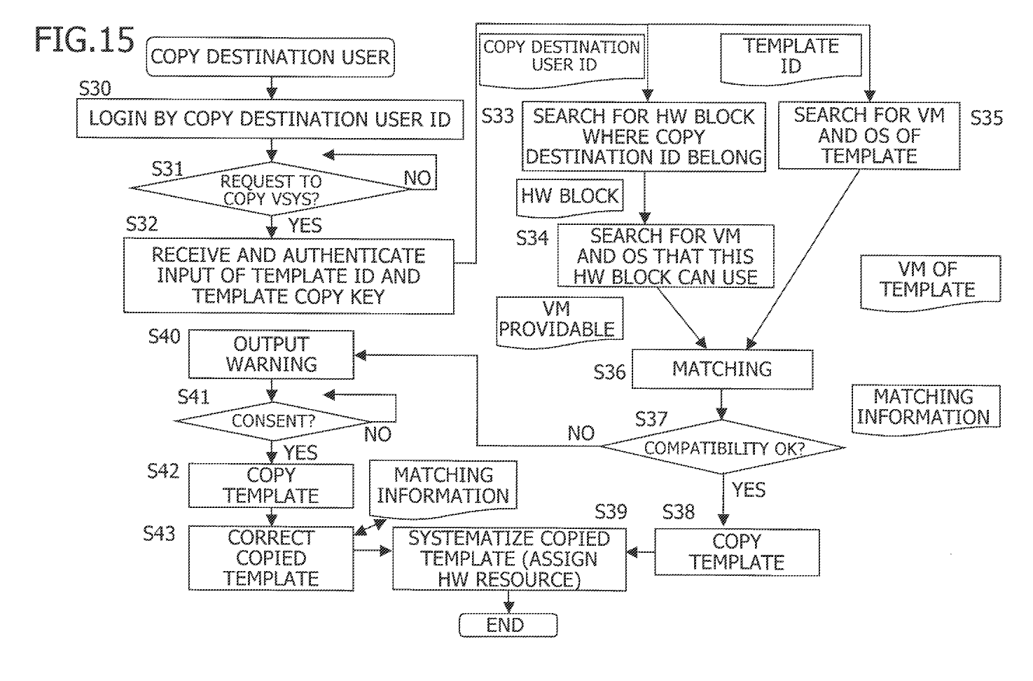

FIG. 15 is a flow chart depicting a virtual system copy processing by the management server for the copy destination user terminal. The copy source user notifies the template ID (ID=TP1C) of the virtual system to be copied and the copy key (COPY-K1) thereof to the copy destination user in advance.

The management server 123 authenticates login from the copy destination user terminal U2 with the copy destination user ID, and accepts the login (S30). When a virtual system copying request is received from the copy destination user terminal U2 (S32), the management server 123 receives notification of a template ID (ID=TP1C) and a template copy key (COPY-K1) from the copy destination user terminal U2 (S32), and authenticates whether the copy destination user is a user registered in the template TP1C, and whether the template copy key COPY-K1 is a correct copy key (S32). This authentication processing is performed by referring to the management table 23 in FIG. 13. Thereby the management server 123 confirms that the copy request is from an authorized copy destination user who is registered by the copy source user.

The management server 123 determines whether the hardware block HBL-A of the copy destination user U2 is able to provide the performance level of the virtual machine in the template TP1C to be copied. In other words, the management server 123 determines whether the hardware in the hardware block HBL-A of the copy destination user U2 is able to be correctly assigned to the template TP1C to be copied. This determination is the same as the determination processing when the virtual system copying request comes from the copy source user terminal U1. However, the OS is not checked when the virtual system copying request comes from the copy destination user terminal U2. This is because the OS has already been checked by the copy source. But this OS may also be checked here for the purpose of reconfirmation.

In the determination processing by the management server 123, the management server 123 refers to the management table 22 in FIG. 1 as illustrated in FIG. 13, and searches for a hardware block with the copy destination user ID (S23). As a result, it is detected that the hardware block with the copy destination user ID=U2 is HBL-A. Then referring to the management tables 20 and 21 in FIG. 8, the management server 123 searches for a virtual machine VM that the hardware block HBL-A is able to provide, that is a virtual machine VM that is able to be used in the hardware block HBL-A (S34).

The management server 123, on the other hand, refers to the management table 23 in FIG. 12, as illustrated in FIG. 13, and searches for a virtual machine VM of the template TP1C to be copied (S35).

As illustrated in FIG. 13 and FIG. 14, the management server 123 matches performance levels between a virtual machine VM that the hardware block of the copy destination user is able to provide and a virtual machine VM of the template TP1C to be copied, and checks whether all the virtual machines VM of the template TP1C to be copied are included in the virtual machines VM that the hardware block of the copy destination user is able to provide (S36).

If it is confirmed that all the virtual machines VM of the template TP1C to be copied are included in the virtual machines VM that the hardware block of the copy destination user is able to provide in the matching processing S36 (YES in S37), the management server 123 transfers and stores the data of the template file TP1C in the hardware block HBL-C of the copy source user to the storage area in the hardware block HBL-A of the copy destination user (S38). A new template ID (ID=TP2) is issued for the copied template. This data transfer processing will be described later.

In the example in FIG. 13, the hardware block HBL-A is not able to provide the performance level VM-L16 of the virtual machine VM in the template TP1C. Therefore the management server 123 determines “Incompatible” (NO in S37), and outputs such a warning as “This template includes a server type (virtual machine type) that cannot be assigned.” or “This template includes a server type (virtual machine type) that cannot be assigned. A server type (virtual machine type) with a lower performance level will be assigned. Is this OK?” to the copy destination user terminal U1 (S40).

If consent to the warning is received from the copy destination user terminal U2, the management server 123 performs copying processing similar to the copy processing S38 of the template (S42). As illustrated in FIG. 13, the template TP2 transferred to the hardware block HBL-A of the copy destination user includes the virtual machine VM-L16, which is a virtual machine the hardware block HBL-A is not able to provide.

Therefore the management server 123 detects a virtual machine VM-L8 of which performance level is closest to the performance level VM-L16 of the virtual machine in the template TP2, out of the virtual machines that the hardware block HBL-A is able to provide, and changes the performance level of the virtual machine VM1 in the template TP2 from VM-L16 to VM-L8 (S43). This change is performed based on the matching information which was detected and created during the matching processing S36. This matching information includes information on VM-L16 and VM-L8.

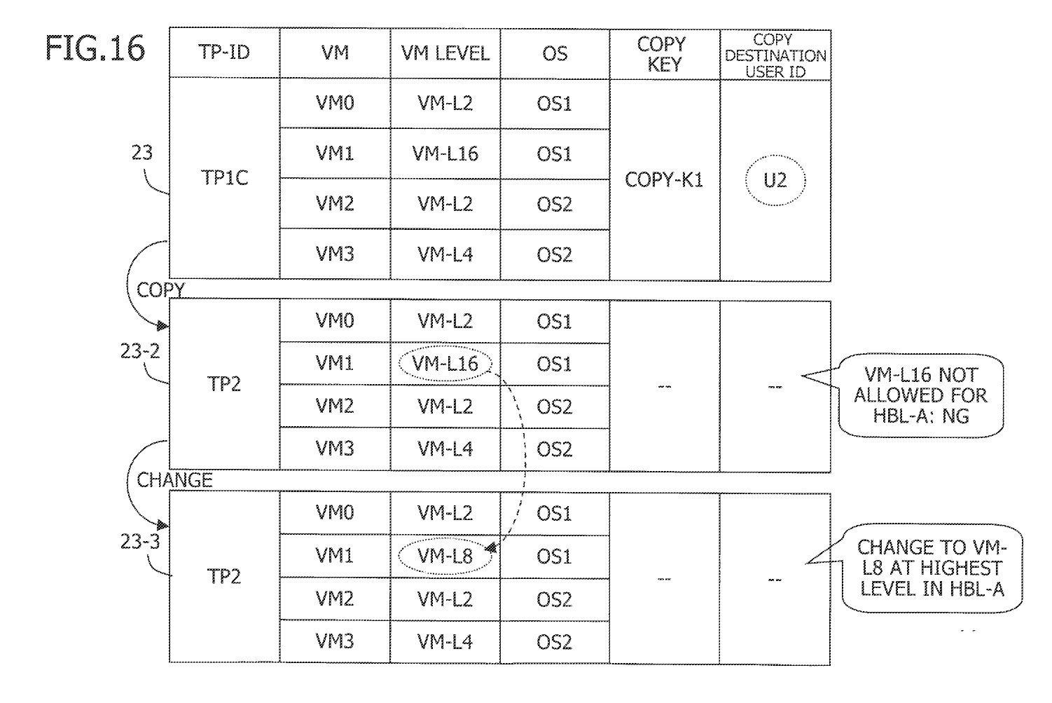

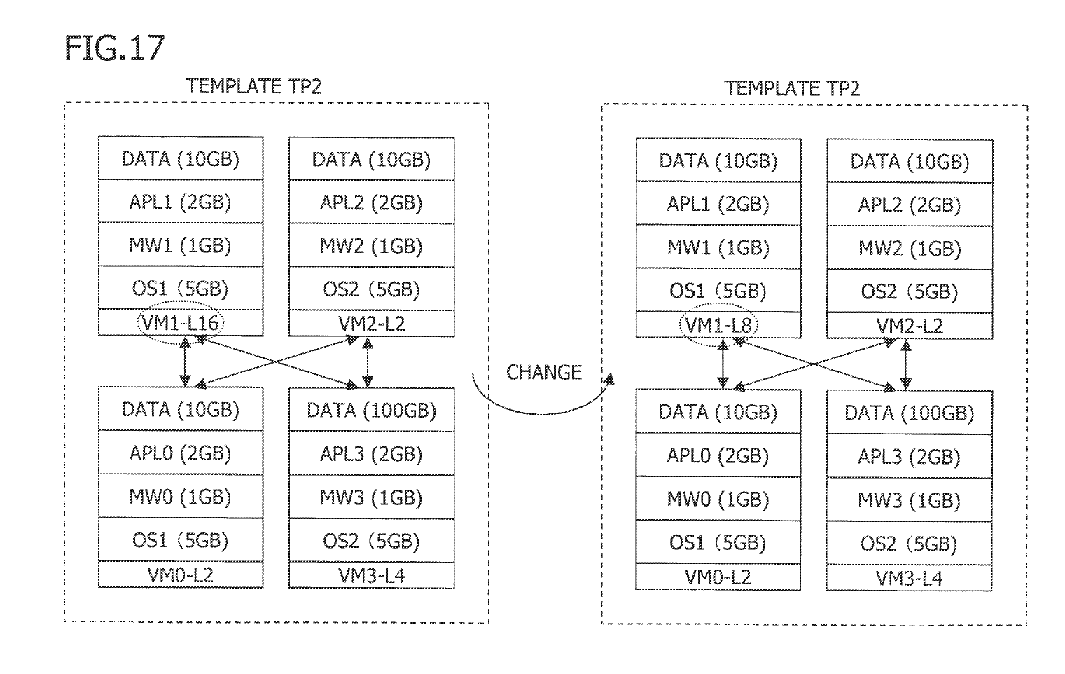

FIG. 16 is a diagram depicting a copy of the template and correction of the copied template. FIG. 17 is a diagram depicting correction of the template in concrete terms. As illustrated in FIG. 16, in the template copying processing S38 and S42, the template TP1C in the hardware block HBL-C of the copy source user U1 is copied to the hardware block HBL-A of the copy destination user U2, and the new template TP2 is generated. This template TP2 includes the virtual machine VM-L16 having a high performance level in the virtual machines, so the virtual machine VM-L16 is not able to be used in the hardware block HBL-A. Hence the virtual machine VM-L8 of which performance level is closest to that of the virtual machine VM-L16, among the virtual machines that is able to be used in the hardware block HBL-A, is selected, and the virtual machine VM-L16 in the template TP2 is changed to VM-L8. This virtual machine VM-L8 is the virtual machine having the highest performance level that the hardware block HBL-A is able to provide.

Finally the management server 123 assigns the hardware resource of this hardware block to the template file TP2 which is copied in the hardware block HBL-A of the copy destination user, and systematizes the template TP2 (S39). Since it has been already verified, the virtual machine or the like in the copied template TP2 are providable in the hardware block HBL-A of the copy destination user, or has already been corrected so that the virtual machine or the like in the copied template TP2 is able to be provided in the hardware block HBL-A, hardware resources is able to be appropriately assigned and systematized.

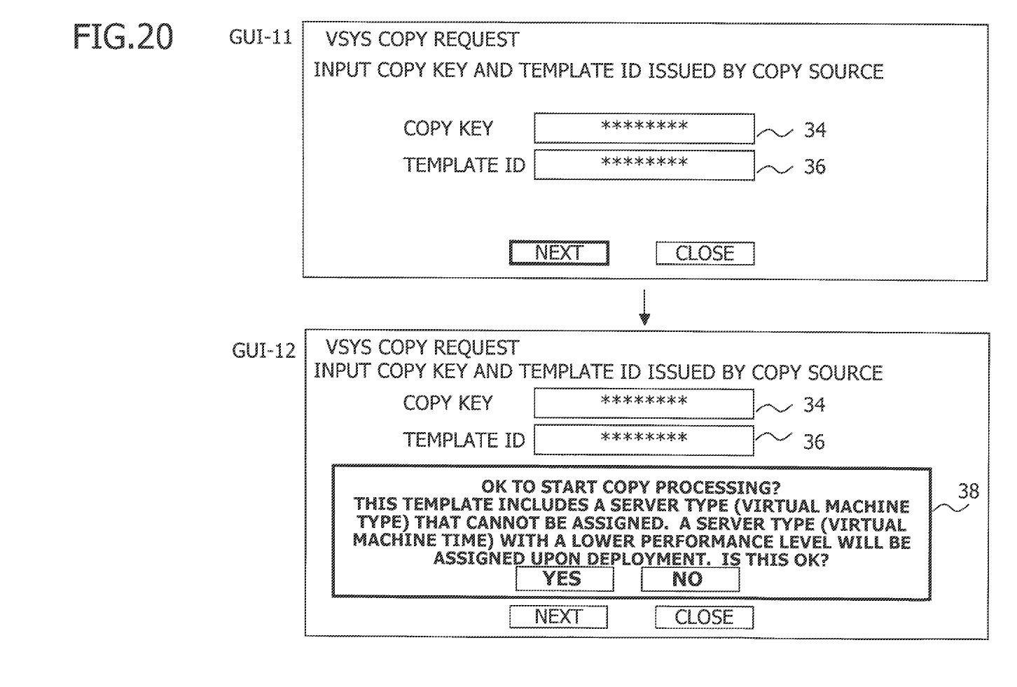

FIG. 20 are examples of user interfaces of the copy destination user terminal. The interface screen GUI-11 in FIG. 20 is a screen for inputting a copy key and a template ID when the VSYS copying request in step S32 in FIG. 15 is executed. If the copy destination user inputs a copy key in an input box 34 and a template ID in an input box 36, and presses the “Next” button, the management server executes steps S33 to S37 in FIG. 15. If the result of the matching processing S36 is “Incompatible”, then box 38 of the above mentioned warning message is displayed in the screen GUI-12. If the copy destination user selects “YES” in the warning message box 38 (S41) to give consent, the management server executes step S42 and step S43.

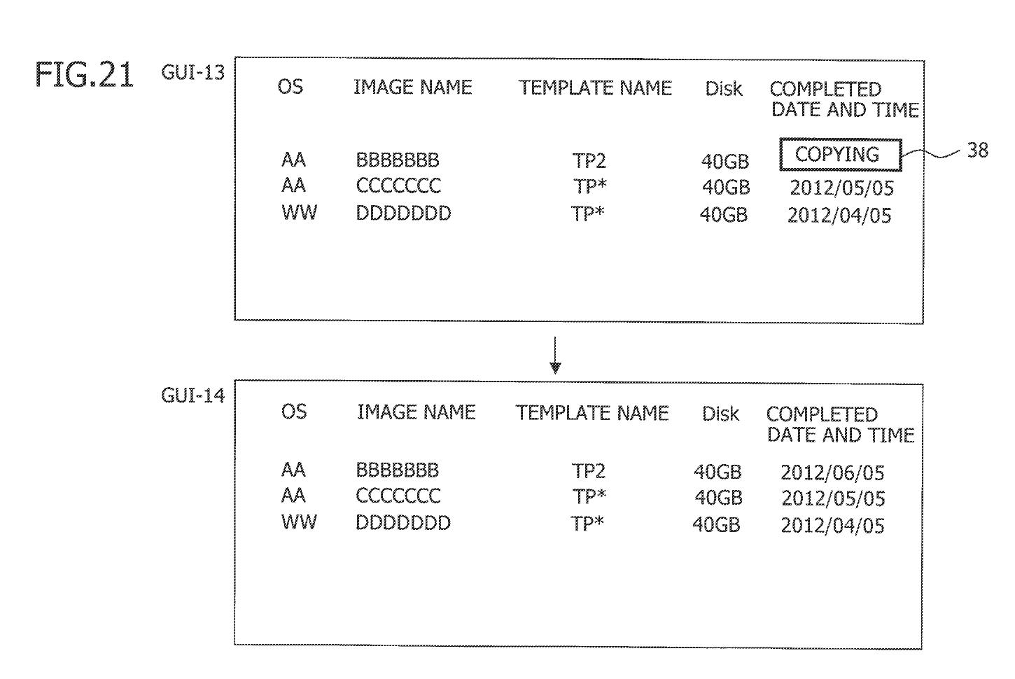

FIG. 21 is a diagram depicting screens during copying the template in step S42. The screen GUI-13 displays a copy list, and in the case of the example in FIG. 21, two templates have already been copied, and “Copying” 38, which indicates that the current template TP2 is now being copied, is displayed at the very top of the list. When copying is completed, the display “Copying” 38 disappears, and the copying completion date and time of the template TP2 is displayed as indicated in the screen GUI-14.

The screens GUI-11 to GUI-14 in FIG. 20 and FIG. 21 are examples when the result of the matching processing S36 is “Incompatible”. If the result of the matching processing S36 is “Compatible”, on the other hand, the screens GUI-11, GUI-13 and GUI-14 are displayed, in other words, the screens during the template copying processing in step S38 when the result of the matching processing is “Compatible”, and the screens during the template copying processing in step S42 when the result of the matching processing is “Incompatible” are both screens GUI-13 and GUI-14. Therefore while causing the user not to recognize the difference of the blocks between the copy source and the copy destination, the management server is able to automatically select an optimum performance and execute copying.

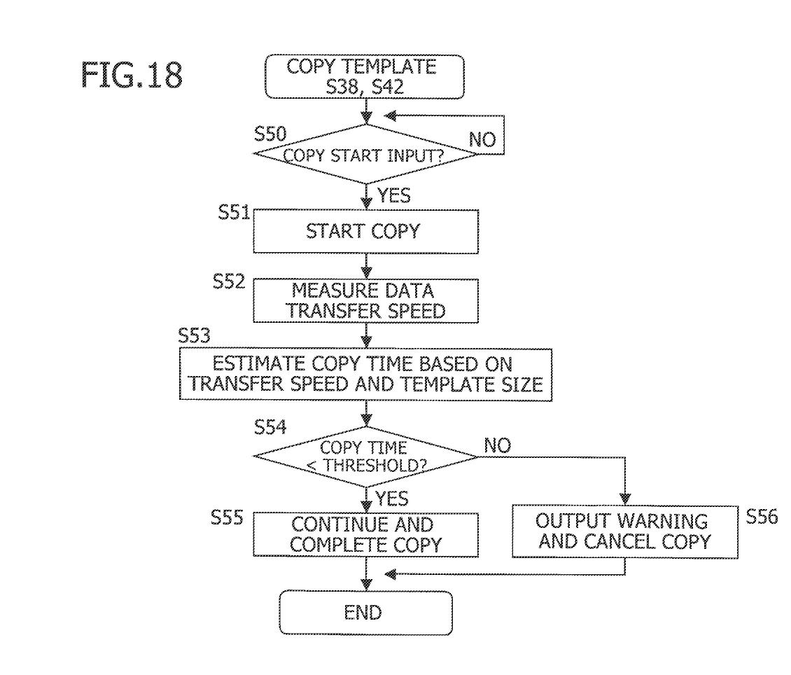

FIG. 18 is a flow chart depicting the template copying processing S38 and S42 in FIG. 15. The template is copied by transferring data of the template TP1C in the hardware block HBL-C of the copy source user to the hardware block HBL-A of the copy destination user. Therefore according to this embodiment, if it takes a long time to transfer the data of the template TP1C, the management server 123 interrupts the template copying processing, and requests the copy destination user terminal U2 to reduce the data volume of the template TP1C of the copy source user.

As depicted in FIG. 18, if a request to copy a VSYS or if a consent to a warning is inputted from the copy destination user terminal U2 (S50), the management server 123 starts to transfer the data of the template TP1C in the hardware block HBL-C of the copy source user to the hardware block HBL-A of the copy destination user (S51). The management server 123 measures the data transfer speed (S52) and estimates the copy time, including the data transfer time based on the transfer speed and the file size of the template TP1C (S53).

If the copy time is a predetermined threshold time or longer (NO in S54), the management server 123 outputs such a warning message as “Processing is cancelled because template copy time is expected to exceed eight hours (threshold time). Request to reduce data size of template of the copy source.”, and cancels the template copying processing (S56). If the copy time is less than the predetermined threshold time (YES in S54), on the other hand, the management server 123 continues the data transfer, and completes the copying processing (S55).

The reason why the management server cancels the copying processing when the estimated data transfer time exceeds the threshold time is because the copy destination user is normally unable to maintain a connection with the server facility until the copying processing completes.

In the processing with the copy destination user terminal U2 as well, the performance level of the virtual machine may vary depending not only on a number of CPUs, but also on the memory capacity or disk capacity. It may be determined whether the hardware block of the copy destination user is able to provide based on these performance levels too.

As described above, in response to a virtual system copying request from the copy destination user terminal U1, the management server determines whether the hardware block of the copy destination user is able to provide the performance level of the virtual machine included in the template of the virtual system, and if the management server is able to handle the request for the copy destination user, the management server outputs a warning to the copy source user terminal, and, if the consent is received, executes the copying processing, and if the consent is not received or if the management server is not able to handle the request for the copy destination user, the management server rejects registration. As a result, the management server is able to appropriately handle a virtual system copying request between different hardware blocks without causing inconvenience to users.

According to this embodiment, the virtual system copying processing between the different hardware blocks of a server facility is able to be appropriately performed without causing inconvenience to the copy source user and the copy destination user.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

1. A server facility comprising:
a hardware resource group including at least a plurality of servers and a plurality of storage units; and
a management server configured to store a user template file that contain information on a virtual system including a plurality of virtual machines, in a storage area, and facilitate the virtual system by assigning hardware in the hardware resource group to the user template file, wherein
the hardware resource group includes a plurality of hardware blocks each of which includes a first number of servers and a second number of storage units, and
in response to a virtual system copying request to copy a copying target virtual system of a first user, to which hardware in a first hardware block of the first user is assigned, to a second hardware block of a second user, the management server determines whether the second hardware block is able to provide a virtual machine in the copying target virtual system of the first user.

2. The server facility according to claim 1, wherein
when the virtual system copying request is authorized, the management server copies a first template file of the copying target virtual system of the first user, so as to generate a second template file of the second user, and constructs a copy destination virtual system by assigning hardware in the second hardware block to the second template file.

3. The server facility according to claim 2, wherein
in response to the virtual system copying request from a terminal of the first user, the management server outputs a first warning when the performance level of the virtual machine that the second hardware block is able to provide does not include the performance level of the virtual machine in the copying target virtual system of the first user.

4. The server facility according to claim 3, wherein
the management server includes, in the first warning, a message that the performance level of the virtual machine in the copy destination virtual system is lowered.

5. The server facility according to claim 2, wherein
in response to the virtual system copying request from a terminal of the first user, the management server does not authorize the virtual system copying request in a case when software to be installed on the virtual machine that the second hardware block is able to provide does not include software that is currently installed on the virtual machine of the copying target virtual system of the first user.

6. The server facility according to claim 2, wherein
in response to the virtual system copying request from a terminal of the second user, the management server outputs a second warning in a case when the performance level of the virtual machine that the second hardware block of the copy destination is able to provide does not include the performance level of the virtual machine in the copying target virtual system of the first user.

7. The server facility according to claim 6, wherein
the management server includes, in the second warning, a message that the performance level of the virtual machine in the copy destination virtual system is lowered.

8. The server facility according to claim 7, wherein
in response to consent from the second user terminal to the message included in the second warning, the management server changes the performance level of the virtual machine in the second template file to a performance level closest to the performance level of the virtual machine in the second template file that the second hardware block is able to provide.

9. The server facility according to claim 2, wherein
in response to the virtual system copying request from the second user terminal, the management server does not authorize the virtual system copying request in a case when data transfer time in the copying processing to generate the second template file by copying the first template file exceeds a predetermined reference time.

10. A method for providing a virtual system copying service at a server facility that includes: a hardware resource group including at least a plurality of servers and a plurality of storage units; and a management server configured to store a template file that contains information on a virtual system including a plurality of virtual machines in a storage area, and facilitate the virtual system by assigning hardware in the hardware resource group to the template file,
the hardware resource group including a plurality of hardware blocks each of which includes a predetermined number of servers and a predetermined number of storage units, the method comprising:
causing the management server to determine, in response to a virtual system copying request to copy a copying target virtual system of a first user, to which hardware in a first hardware block of the first user is assigned, to a second hardware block of a second user, whether the second hardware block is able to provide a virtual machine in the copying target virtual system of the first user.

11. The method for providing a virtual system copying service at the server facility according to claim 10, the method further comprising:
causing the management server to copy, when the virtual system copying request is authorized, a first template file of the copying target virtual system of the first user, so as to generate a second template file of the second user, and to construct a copy destination virtual system by assigning hardware in the second hardware block to the second template file.

12. A virtual system copying program executed by a management server at a server facility that includes: a hardware resource group including at least a plurality of servers and a plurality of storage units; and the management server configured to store a template file that contains information on a virtual system including a plurality of virtual machines in a storage area, and facilitate the virtual system by assigning hardware in the hardware resource group to the template file,
the hardware resource group including a plurality of hardware blocks each of which includes a predetermined number of servers and a predetermined number of storage units,
the virtual system copying program causing the management server to perform:
determining, in response to a virtual system copying request to copy a copying target virtual system of a first user, to which hardware in a first hardware block of the first user is assigned, to a second hardware block of a second user, whether the second hardware block is able to provide a virtual machine in the copying target virtual system of the first user.

13. The virtual system copying program at the server facility according to claim 12, the virtual system copying program further causing the management server to perform:
copying, when the virtual system copying request is authorized, a first template file of the copying target virtual system of the first user, so as to generate a second template file of the second user, and to construct a copy destination virtual system by assigning hardware in the second hardware block to the second template file.
